(19) United States
(12) Patent Application Publication
(10) Pub. No.: US 2011/0161158 A1
(43) Pub. Date: Jun. 30, 2011

(54) METHOD AND SYSTEM FOR PROVIDING DISCOUNT INFORMATION

(75) Inventor: Bing-Jin Lin, Taipei (TW)

(73) Assignee: ENTERTAINMENT MACHINE OPERATOR, Taipei (TW)

(21) Appl. No.: 12/647,379

(22) Filed: Dec. 24, 2009

(51) Int. Cl. G06Q 30/00; G01C 21/00; G06F 17/30; G06F 17/00

(52) U.S. Cl. 705/14.36; 701/300; 705/14.1; 707/780; 235/375; 707/E17.014; 235/454

(57) ABSTRACT

A method for providing discount information and the system thereof are provided. The method includes acquiring an identifier of a selected item and coordinates of the client device, searching for items relevant to the selected item in a storage system, and refining the search results according to the coordinates of the client device. The method further includes sending corresponding discount information of the search results to the client device if at least one item in the storage system is determined to be relevant to the selected item.

### BACKGROUND

1. Technical Field

Embodiments of the present disclosure relate to discount information, and more particularly to a method and a system for providing discount information.

2. Description of Related Art

Nowadays, electronic coupons are a useful marketing tool to stimulate consumers to purchase a particular product. As most consumers now own and operate a cellular phone or other portable electronic device, the consumers may download the electronic coupons by the cellular phone in advance, and then show the corresponding electronic coupons to clerks when purchasing products in a store.

However, it is troublesome for the consumers to download the corresponding electronic coupons in advance. In addition, if the consumers choose to download the electronic coupons automatically, there may be a lot of unnecessary electronic coupons being downloaded to the cellular phone.

Accordingly, a method and a system for providing discount information are called for in order to overcome the limitations described.

### BRIEF DESCRIPTION OF THE DRAWINGS

FIG. 1 is a system view of one embodiment of a system for providing discount information.

FIG. 2 is a block diagram of one embodiment of a client device.

FIG. 3 is a exemplary embodiment of an electronic coupon shown on the client device.

FIG. 4 is a flowchart of one embodiment of a method for providing discount information.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

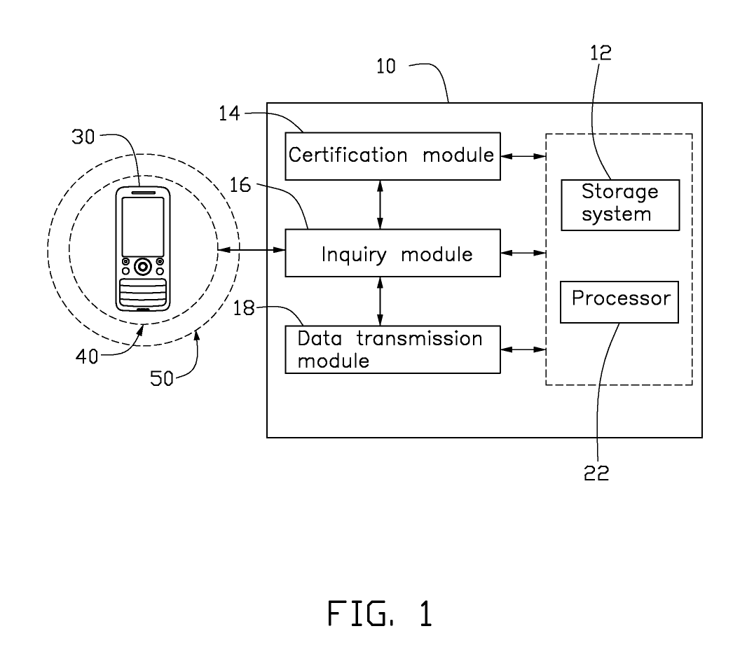

FIG. 1 is a system view of one embodiment of a discount information system 10. The discount information system 10 may be used to provide discount information to at least one client device 30 in a first range 40. In one example, the first range 40 may relate to a physical range of a shopping center. In addition, a second range 50 may relate to a predefined range which is larger than the first range.

The discount information system 10 includes a storage system 12, a certification module 14, an inquiry module 16, and a data transmission module 18. A processor 22 may be used to execute one or more computerized operations for the modules 14-18.

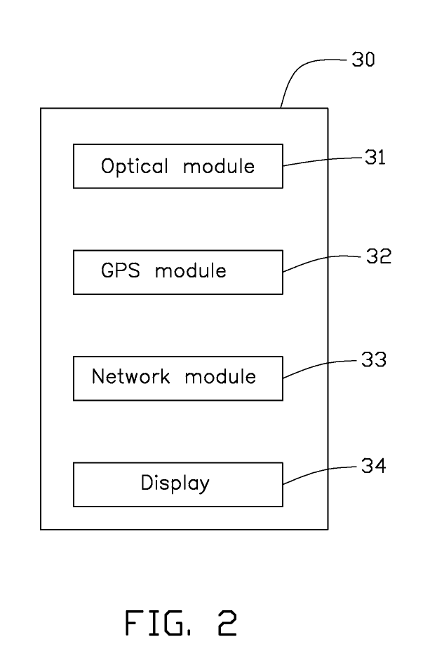

As shown in FIG. 2, the client device 30 includes at least one optical module 31, a Geo Positioning System (GPS) module 32, a network module 33, and a display 34. In the illustrated embodiment, the client device 30 is a mobile phone, although other client devices, such as notebook computers, and personal digital assistants (PDAs), for example, are equally applicable while fully maintaining the scope of the disclosure.

An example of one method of using the discount information system 10 is detailed below. However, it should be understood that the detailed embodiment is one example of a use of the present disclosure, and should not be limited thereto. In one embodiment, a user who is carrying the client device 30 may be shopping within the first range 40, such as a physical range of a department store. Upon locating a selected item (e.g., a book), the client device 30 is operable to obtain an identifier of the selected item. For example, the client device 30 may be used to take an image or scan an identity number of the selected item using the optical module 31. For example, the identity number may be a barcode or a QR-code. The client device 30 then connects to the discount information system 10 by the network module 33. In one exemplary example, the optical module 31 may include a camera of the client device 30.

The certification module 14 of the discount information system 10 is operable to perform a certification process for the discount information system 10. The certification process is performed by entering an account name and a corresponding password by the client device 30.

After the client device 30 has been successfully authenticated, the inquiry module 16 of the discount information system 10 is operable to receive the identifier of the selected item and GPS coordinates of the client device 30 transmitted from the network module 33 of the client device 30. The network module 33 is operable to make cellular interconnections to mobile wireless users via wireless local area networks (WLAN) and/or other wideband networks. In one exemplary example, the network module 33 is an IEEE 802.x or a BLUETOOTH module.

The inquiry module 16 is operable to search for relevant items in the storage system 12 using the identifier and the GPS coordinates of the client device 30 to refine the search results. For example, if the image of the selected item relates to a specific model of a digital camera, the inquiry module 16 searches for the specific model of the digital camera in the storage system 12. In addition, the GPS coordinates of the client device 30 is utilized so that the inquiry module 16 only searches for the specific model within the first range 40. The storage system 12 may comprise a database system comprising a searchable database of a plurality of items. In one example, the storage system may comprise a hard disk drive.

If there is no the specific model within the first range 40, the inquiry module 16 is operable to search for relevant items within the first range 40 in the storage system 12.

If there is no relevant item within the first range 40, the inquiry module 16 is operable to search for relevant item within the second range 50 in the storage system 12.

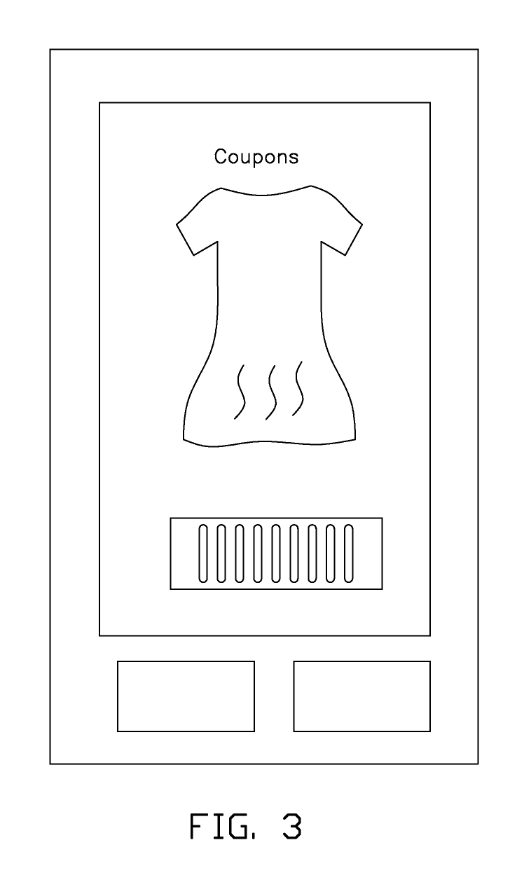

The data transmission module 18 is operable to send corresponding discount information to the client device 30 if at least one item in the storage system 12 is determined as being relevant to the selected item. In one embodiment, the corresponding discount information includes electronic coupons related to the selected item. In one exemplary example, the data transmission module 18 sends the electronic coupons corresponding to the selected item to the client device 30. As shown in FIG. 3, the customers carrying the client device 30 may use the electronic coupons shown in the display 34 of the client device 30 right away. In another embodiment, the corresponding discount information may include discount criteria provided by a plurality of credit cards issuing banks/companies. For example, the customers carrying the client device 30 may select one credit card having the lowest discount to pay for the selected item.

The data transmission module 18 is also operable to receive the discount information from authenticated users. After receiving the discount information from the client device 30, the data transmission module 18 is operable to store the discount information in the storage system 12 so as to integrate the discount information stored therein.

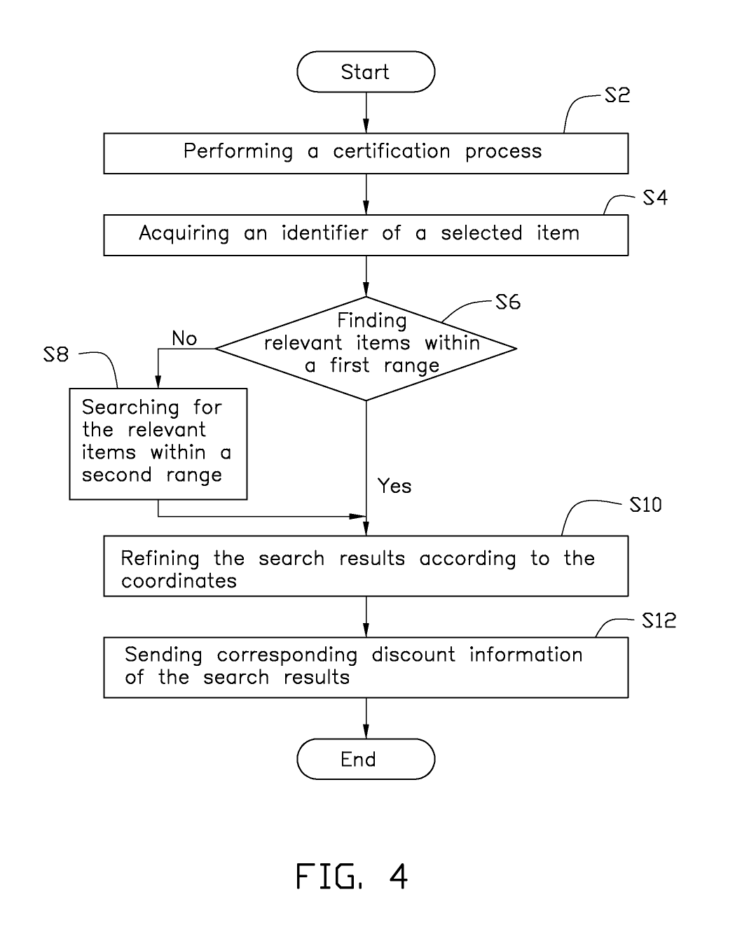

FIG. 4 is a flowchart of one embodiment of a method for providing discount information. The method of FIG. 4 may used for providing discount information regarding a selected item for the client device 30. Depending on the embodiment, additional blocks may be added or deleted and the blocks may be executed in order other than that described.

In block S2, the certification module 14 performs a certification process for the client device 30.

In block S4, the inquiry module 16 acquires an identifier of a selected item and the GPS coordinates of the client device 30. The identifier of selected item is determined by capturing an image or scanning an identity number of an item by the optical module 31 of the client device 30. In addition, the GPS coordinates are provided by the GPS module 32 of the client device 30.

In block S6, the inquiry module 16 searches for the relevant items within a first range in the storage system 12.

If there is no relevant item found within the first range in the storage system 12, in block S8, the inquiry module 16 searches for the relevant items within a second range in the storage system 12.

In block S10, the inquiry module 16 refines the search results according to the GPS coordinates of the client device 30.

In block S12, the data transmission module 18 sends corresponding discount information of the search results to the client device 30. The corresponding discount information includes coupons related to the selected item or discount criteria provided by a plurality of credit cards issuing banks/companies.

It is important to note that while the disclosure has been described in the context of a fully functioning data processing system, those of ordinary skill in the art will appreciate that the processes of the disclosure are capable of being distributed in the form of a computer readable medium of instructions and a variety of forms and that the disclosure applies equally regardless of the particular type of signal bearing media actually used to carry out the distribution. Examples of computer readable media include recordable-type media such as floppy disc, a hard disk drive, random access memory (RAM), and compact disc-read only memory (CD-ROM), as well as transmission-type media, such as digital and analog communications links.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computer-implemented discount offering method, the method comprising:
at a client device comprising at least one optical module,
acquiring an identifier of a selected item and coordinates of the client device using the at least one optical module;
searching for items relevant to the selected item in a storage system of a discount information system;
refining the search results according to the coordinates of the client device; and
sending corresponding discount information of the search results to the client device if at least one item in the storage system is determined to be relevant to the selected item.

2. The discount offering method as claimed in claim 1, wherein the at least one optical module takes an image of the selected item.

3. The discount offering method as claimed in claim 1, wherein the step of acquiring the identifier further comprises:
reading an identity number of the selected item.

4. The discount offering method as claimed in claim 1, wherein the coordinates are provided by a Geo Position System (GPS) module in the client device.

5. The discount offering method as claimed in claim 1, wherein the step of using the identifier to search for the relevant item further comprises:
searching the relevant items within a first range in the storage system.

6. The discount offering method as claimed in claim 5, wherein the step of using the identifier to search for the relevant item further comprises:
searching the relevant items within a second range in the storage system if there is no relevant item found within the first range in the storage system.

7. The discount offering method as claimed in claim 1, wherein the corresponding discount information comprises coupons related to the selected item.

8. The discount offering method as claimed in claim 1, wherein the corresponding discount information comprises discount criteria provided by a plurality of credit cards issuing banks/companies.

9. A discount information system, comprising:
a storage system to store information;
a certification module to grant access to registered users of the discount information system;
an inquiry module to receive an identifier of a selected item and coordinates of a client device, search for relevant items in the database using the identifier and the coordinate of the client device to refine the search results; and
a data transmission module to send corresponding discount information to the client device if at least one item in the database is determined as being relevant to the selected item.

10. The discount information system as claimed in claim 9, wherein the identifier is an image of the selected item.

11. The discount information system as claimed in claim 9, wherein the identifier is an identity number of the selected item.

12. The discount information system as claimed in claim 9, wherein the inquiry module is configured for searching the relevant items within a first range in the database.

13. The discount information system as claimed in claim 12, wherein the inquiry module is configured for searching the relevant items within a second range in the database if there is no relevant items found within the first range in the database.

14. The discount information system as claimed in claim 9, wherein the corresponding discount information comprises coupons related to the selected item.

15. The discount information system as claimed in claim 9, wherein the corresponding discount information comprises discount criteria provided by a plurality of credit cards issuing banks/companies.

16. The discount information system as claimed in claim 9, wherein the data transmission module is configured for receiving the discount information from the registered users.

17. A computer-readable medium for providing discount information, the computer-readable medium having stored thereon instructions that, when executed by an electronic device, cause the electronic device to:
at a client device comprising at least one optical module,
acquire an identifier of a selected item and coordinates of the client device using the at least one optical module;
search for items relevant to the selected item in a storage system of a discount information system;
refine the search results according to the coordinates of the client device; and
send corresponding discount information of the search results to the client device if at least one item in the storage system is determined to be relevant to the selected item.

18. The computer-readable medium as claimed in claim 17, wherein the at least one optical module takes an image of the selected item.

19. The computer-readable medium as claimed in claim 17, wherein the step of acquiring the identifier further comprises:
read an identity number of the selected item.

20. The computer-readable medium as claimed in claim 17, wherein the coordinates are provided by a Geo Position System (GPS) module in the client device.
